(19) United States
(12) Patent Application Publication
(10) Pub. No.: US 2005/0015266 A1
(43) Pub. Date: Jan. 20, 2005

(54) Commerce training using mythological framework

(76) Inventor: Dawn Duane Evans, Kalispell, MT (US)

Correspondence Address: Burkhart & Burkhart;Patent Attorneys, 940 Dakota Avenue, Whitefish, MT, 59937, US

(21) Appl. No.: 10/620,165

(22) Filed: Jul. 14, 2003

(51) Int. Cl. G06F 17/60

(52) U.S. Cl. 705/1; 705/2

(57) ABSTRACT

A method is described for conducting an exchange for value in the context of a tradition associated with deciduous teeth. The method includes the step of providing a token redeemable for value at a predetermined place of business. The tooth is handled in accordance with the tradition. The tooth is replaced with the token, which is subsequently redeemed at the place of business.

### FIELD OF THE INVENTION

The present invention relates generally to training in commerce using mythological background material, and particularly to such training via established cultural mythology such as the Tooth Fairy.

### BACKGROUND OF THE INVENTION

Rituals and customs surrounding the loss of deciduous teeth by children are spread throughout the world, and date from antiquity. Today's tooth fairy practice in the United States, in which the tooth fairy exchanges money for a tooth left under a pillow while the child is asleep, has its roots in a variety of traditions. Researcher Genevieve Thiers, writing for Pagewise, Inc., date one example from Viking times, in which a “tooth fee” was given to children upon the loss of a tooth. The teeth were later strung to make jewelry. Although surrounded in mystery, the tooth fee is thought to be associated with early Viking beliefs that children's articles and pieces contained great power. Having an article of a child, or a child in one's possession was supposed to bring power and luck in battle.

Tradition in England holds that if a child's tooth falls out, that child must drop it into a fire, to avoid having to look for it after death. This tale was handed down during the Middle Ages to smaller children during the teething stage. The addition of fire into the mix may have conjured up images of sorcery. Early alleged witches were often burned because people believed money appeared after they threw articles into fire. From this tale comes the importance of keeping a tooth. When a witch burned a piece of hair, clothing or teeth from a person, she supposedly obtained power over them. Parents may have scared children into keeping teeth or burning them themselves in order to keep themselves free of demon possession.

In some European traditions, a mouse is said to take the teeth, leaving small gifts, coins or candy in their place. In other countries, including Japan, Vietnam and Korea, the teeth are thrown over the roof or under the house.

Not surprisingly, the tooth fairy tradition has been adapted to modern practices, such as dental hygiene education, and has found its way into the patent literature. For example, U.S. Pat. No. 5,244,394 to Serabian-Musto is directed to an educational dental kit for entertaining and educating young children about both the mythological “Tooth Fairy” and about good dental hygiene. The kit comprises a greeting card, a poster, and a drawstring pouch. The poster portrays a child's face with particular emphasis on the mouth. The teeth on the mouth are printed on removable stickers, each sticker representing a different tooth. When the child loses a tooth, the corresponding sticker is removed from the poster and is placed in the appropriate location on the greeting card. Indicia describing the teeth as well as proper dental hygiene may be located on the poster. The greeting cards may include indicia in the form of an image or text. The greeting cards may also encourage active participation of the child. A number corresponding to the order in which each tooth is lost may also be provided on each greeting card. The numbers would appear in ascending order on each successive greeting card. The first time a tooth is lost, the child should receive the first card. When the second tooth is lost by the child, the second greeting card should be presented, when the third tooth is lost, the third greeting card should be presented, and so on. A drawstring bag is included in the kit to provide a way for the parent to quickly and efficiently locate and retrieve the lost tooth from under the child's pillow.

The Tooth Fairy concept is also employed in U.S. Pat. No. 5,501,602 to Anderson, which sets forth a dental care kit for simulating a visit of a fictional tooth fairy and instructing a child of the importance of proper dental care. The kit includes a storage chest containing a plurality of envelopes, magical fairy dust contained within a fairy dust container, an ink pad, left and right foot stamps, a coin bag, and a plurality of written notes. A method of utilizing the kit includes placing a deciduous tooth within one of the envelopes and underneath a pillow of the child's sleeping accommodations. After the child falls asleep, a parent of the child removes the tooth in the envelope for storage within the chest, sprinkles the magical fairy dust around and about the child, utilizes the left and right foot stamps and ink pad to place footprints on or about the child, places an amount of money within the coin bag underneath the pillow, and leaves one of the written notes underneath the pillow along with the coin bag. The fairy dust and footprints thus serve to convince the child of the existence of the fictional tooth fairy, while instructional indicia printed on the written notes instructs the child of the importance of proper dental care.

U.S. Pat. No. 5,522,507 to Cruz deals with a kit including all the items necessary to enact the tooth fairy fable, and a container for those items. Preferably, the container and the items are all marked with a tooth fairy emblem. The items include an electric lamp in the shape of a tooth fairy and preferably made of translucent material with the lamp light source within the body of the lamp. In addition, a string pouch or the like, preferably with a bell attached, is provided for placing a tooth therein and for receiving a coin in exchange for the tooth. A pillow case is also included, preferably with a tooth-receiving front pocket. The items further include a tooth receptacle for permanently retaining one or more teeth, preferably with date markers for the same. The receptacle preferably is in the form of a pair of hinged jaws, with tooth-receiving openings corresponding to the positions of baby teeth in the jaws. The kit also includes a container of dispensable gold-colored powder to indicate the recent presence of the tooth fairy. An instruction booklet on the proper procedure for enacting the tooth fairy fable and a note pad and pencil for communicating with the tooth fairy, as well as a tea set with serving tray, tea cups and tea pitcher may also be provided in the kit. Preferably, the items in the kit are miniaturized for use with and by a child.

It can thus be seen from the foregoing that several attempts have been made to use the tooth fairy tradition as a vehicle for educating children in dental hygiene practices. However, although the dental aspect of the tooth fairy tale has been exploited in a variety of ways. For example, the tradition encompasses monetary aspects that, beyond the transfer of wealth from parent to child, have been largely ignored. that the need exists for a method and apparatus for employing the tooth fairy tradition to provide training and education regarding handling and stewardship of money, such as saving, investing, and the like, while reinforcing and enhancing the experience of the tradition itself.

### SUMMARY OF THE INVENTION

A method is described for conducting an exchange for value in the context of a tradition associated with deciduous teeth. The method includes the step of providing a token redeemable for value at a predetermined place of business. The tooth is handled in accordance with the tradition. The tooth is replaced with the token, which is subsequently redeemed at the place of business.

### DESCRIPTION OF THE DRAWINGS

FIG. 1 illustrates a kit in accordance with the principles of the present invention.

FIG. 2 is a schematic diagram outlining a method in accordance with the principles of the present invention.

FIG. 3 is a schematic perspective view of an obverse side of a token for use in accordance with the principles of the present invention.

FIG. 4 is a schematic perspective view of a reverse side of the FIG. 3 token.

### DETAILED DESCRIPTION OF THE INVENTION

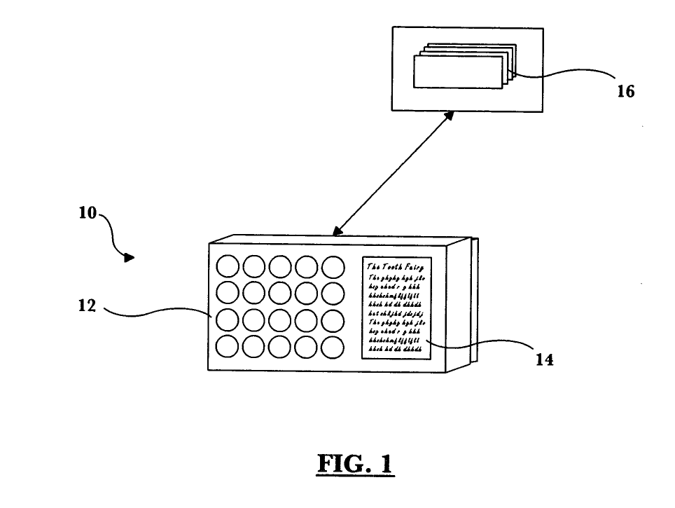

FIG. 1 illustrates a kit 10 in accordance with the principles of the present invention. The kit 10 includes a set of one or more tokens 12. The tokens 12 can be provided as coins or other objects consistent with a particular tradition surrounding deciduous teeth. It is contemplated that the tokens 12 are particularly well suited for use in association with the “Tooth Fairy” tradition popular in the United States and elsewhere. Although tokens could be sold individually, it is contemplated that tokens 12 could be marketed in sets of 20, corresponding to the number of human deciduous teeth. Having all 20 tokens on hand would avoid difficulties arising when children lose teeth at times or in places when parents enacting the tradition in a conventional manner could be caught without sufficient cash on hand. Also included with the tokens 12 are a set of instructions 14 detailing for the adult the steps in redeeming the tokens, and perhaps other materials suggesting ways to enhance the Tooth fairy experience for the child.

The kit 10 further encompasses a set 16 representing a group of services and products held at a place of business earmarked for exchange with the tokens 12. It is contemplated that a business such as a bank would be a suitable fit for seamless integration into the Tooth Fairy tradition. The set 16 could include financial instruments such as cash, bonds, stock, and/or securities, as will be described in detail.

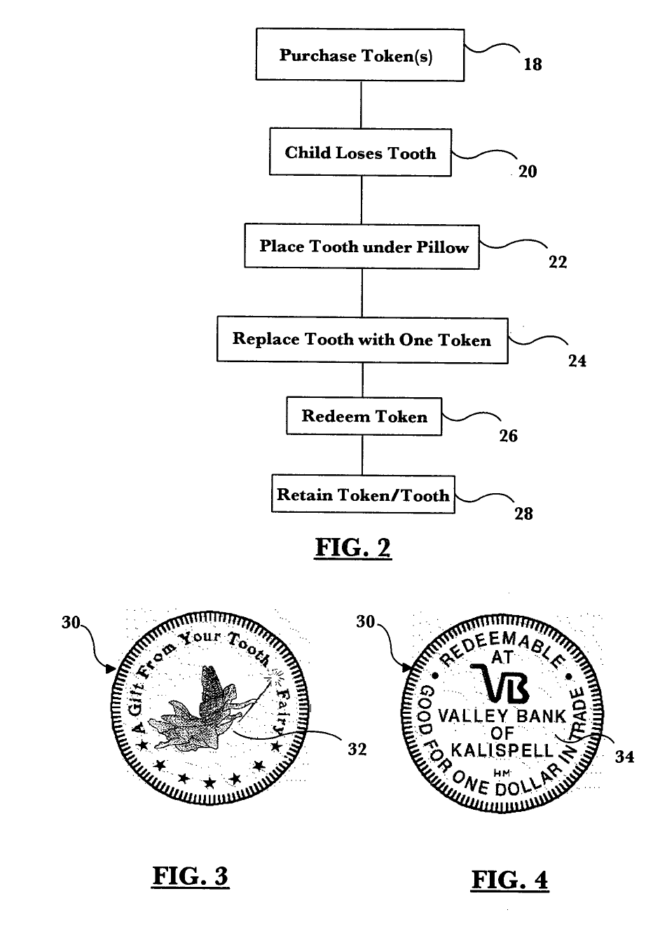

FIG. 2 illustrates the steps involved in practicing the present invention. First, at 18, the user purchases the token or token set from a business. The tokens can be marketed discreetly by the business, so as to target adult audiences and avoid spoiling the magic for children. Tokens can be marketed to those likely to be involved with children of “tooth-losing” age and younger, such as new parents, parents with new accounts, grandparents, expectant parents, and their friends and relatives. After the child loses a tooth at step 20, the tooth is placed in accordance with the relevant tradition at step 22. In the Tooth Fairy tradition, the tooth is placed under the child's pillow and, at step 24, replaced with a token. After the child has discovered the token the next morning, the token is redeemed at the place of business, in step 26. If the place of business is a bank, the token and/or the tooth can be retained in a safe deposit box or the like for later retrieval at step 28. This would enhance the experience by saving a keepsake for the child later in life.

The obverse side of a token, shown as a coin 30, is illustrated in FIG. 3. The coin 30 bears graphics and other indicia 32 relating to the tradition, here the Tooth fairy tradition. As shown in FIG. 4, the reverse side bears information and indicia 34 relating to the place of business. The information can refer to specific redemption value, or merely instruct the user to redeem the coin 30. The coin 30 can be of any suitable size. It is contemplated that it should be large enough to seem “special” and to eliminate choking hazards. For example, diameters of approximately 30 mm, 1.073 inches, 1.125 inches, or 1.25 inches, with a diameter of approximately 0.070 inches would be suitable, with a diameter of 1.25 inches being currently contemplated as preferable. The material should be chosen to be attractive and durable, such as polished golden brass. It is not necessary that the coin have any great intrinsic value.

The token can be redeemed for a suitable reward at the place of business. In the case of a banking institution, the token can be redeemed for any suitable financial instrument. Educational materials relating to banking and finance, perhaps also tied to a Tooth Fairy theme, could be distributed as well. The particular item can be the same for each token, or could be selected to teach a different aspect of financial dealings appropriate to the age and level of understanding of the child. For example, while the first token could be exchanged for cash and be accompanied by an introduction to the bank, later teeth could be exchanged for bonds maturing when the child reaches a specific age, and be accompanied by introducing basic concepts of investments and interest. The child would then look forward not only to the reward, but to attention surrounding the trip to the bank. The bank or other place of business gets an advertising benefit, accrues goodwill in the community, and builds its future customer base.

Although the present invention has been described with reference to specific embodiments, those of skill in the art will recognize that changes may be made thereto without departing from the scope and spirit of the invention as defined by the appended claims.

1. A method for conducting an exchange for value in the context of a tradition associated with deciduous teeth, the method comprising the following steps:
providing a token redeemable for value at a predetermined place of business;
handling the tooth in accordance with the tradition;
replacing the tooth with the token; and
redeeming the token at the place of business.

2. A method in accordance with claim 1, wherein the step of providing a token comprises providing at least one coin.

3. A method in accordance with claim 2, wherein the step of providing at least one coin comprises providing at least one coin bearing tradition-related indicia.

4. A method in accordance with claim 3, wherein the step of providing at least one coin comprises providing at least one coin bearing tooth fairy related indicia.

5. A method in accordance with claim 4, wherein the step of providing at least one coin comprises providing a set of twenty coins.

6. A method in accordance with claim 1, wherein the step of redeeming the token at the place of business comprises redeeming the token at a bank in exchange for financial instruments.

7. A method in accordance with claim 6, wherein the step of redeeming the token at a bank comprises redeeming the token for a financial instrument selected for a group consisting of bonds, cash, stock, and securities.

8. A method in accordance with claim 1, wherein further comprising the step of retaining the token as a keepsake for later retrieval by the child.

9. A method in accordance with claim 1, wherein further comprising the step of retaining the token and the tooth associated therewith as keepsakes for later retrieval by the child.

10. A method for banking in the context of a tradition associated with deciduous teeth of a child, the method comprising the following steps:
providing a token associated with a predetermined bank;
handling the tooth in accordance with the tradition;
replacing the tooth with the token; and
instructing the child to redeem the token at the bank; and
providing the child with banking services and products in exchange for the token.

11. A method in accordance with claim 10, wherein the step of providing a token comprises providing at least one coin.

12. A method in accordance with claim 11, wherein the step of providing at least one coin comprises providing at least one coin bearing tradition-related indicia.

13. A method in accordance with claim 12, wherein the step of providing at least one coin comprises providing at least one coin bearing tooth fairy related indicia.

14. A method in accordance with claim 13, wherein the step of providing at least one coin comprises providing a set of twenty coins.

15. A method in accordance with claim 10, wherein the step of redeeming the token at a bank comprises redeeming the token for a financial instrument selected for a group consisting of bonds, cash, stock, and securities.

16. A kit for conducting an exchange for value in the context of a tradition associated with deciduous teeth of a child, the kit comprising the following:
at least one token associated with a predetermined place of business, the token being suitable for enacting the tradition; and
a predetermined group of services and products held at the place of business earmarked for exchange with the at least one token.

17. A kit in accordance with claim 12, wherein the at least one token comprises at least one coin.

18. A kit in accordance with claim 17, wherein the at least one coin comprises at least one coin bearing tradition-related indicia.

19. A kit in accordance with claim 18, wherein the at least one coin comprises at least one coin bearing tooth fairy related indicia.

20. A kit in accordance with claim 19, wherein the at least one coin comprises a set of twenty coins, with the respective coins being individually redeemable with a respective deciduous tooth.
